(19) United States
(12) Patent Application Publication
(10) Pub. No.: US 2007/0159922 A1
(43) Pub. Date: Jul. 12, 2007

(54) 3-D sonar system

(76) Inventors: Matthew Jason Zimmerman, Providence, RI (US); Matthew Alden Coolidge, Providence, RI (US); Evan Mikel Lapisky, Narragansett, RI (US)

Correspondence Address: BROWN, RUDNICK, BERLACK & ISRAELS, LLP., BOX IP, 18TH FLOOR, ONE FINANCIAL CENTER, BOSTON, MA, 02111, US

(21) Appl. No.: 11/581,626

(22) Filed: Oct. 16, 2006

Related U.S. Application Data
(63) Continuation-in-part of application No. 10/856,871, filed on Jun. 1, 2004, now Pat. No. 7,123,546.
(63) Continuation-in-part of application No. 10/862,342, filed on Jun. 8, 2004, now Pat. No. 7,173,879.
(63) Continuation-in-part of application No. 11/399,869, filed on Apr. 7, 2006.
Application No. 11/399,869 is a continuation of application No. 10/688,034, filed on Oct. 17, 2003, now Pat. No. 7,035,166.
Application No. 11/399,869 is a continuation-in-part of application No. 10/177,889, filed on Jun. 21, 2002, now abandoned.
(60) Provisional application No. 60/474,402, filed on Jun. 2, 2003.
(60) Provisional application No. 60/476,836, filed on Jun. 9, 2003.
(60) Provisional application No. 60/419,728, filed on Oct. 21, 2002.
(60) Provisional application No. 60/299,864, filed on Jun. 21, 2001.

(51) Int. Cl. G01S 15/00

(52) U.S. Cl. 367/103

(57) ABSTRACT

A 3-dimensional sonar system having a fixed frame of reference including a transmitter and receiver array. The system may include a single ping processor for processing received echoes from a single transmission including methods to match filter sonar sensor data, to optionally compensate for self Doppler, beamform sonar sensor data, to extract bottom targets from beamformed data and to extract in-water targets from the beamformed data. The system may also include a multi ping processor to operate on the outputs of multiple pings from the single ping processor including methods to detect tracks from in-water targets.

### RELATED APPLICATION INFORMATION

This patent application is a continuation-in-part of U.S. Utility patent application Ser. No. 10/856,871, filed in the U.S. patent and Trademark Office on Jun. 1, 2004, which takes priority to U.S. Provisional Application No. 60/474,402, filed in the U.S. patent and Trademark Office on Jun. 2, 2003, and is a continuation-in-part of U.S. Utility patent application Ser. No. 10/862,342, filed on Jun. 8, 2004, which takes priority to U.S. Provisional Application No. 60/476,836, filed on Jun. 9, 2003, and is a continuation-in-part of U.S. Utility patent application Ser. No. 11/399,869, filed on Apr. 7, 2006, which is a continuation application of U.S. Utility patent application Ser. No. 10/688,034, filed on Oct. 17, 2003, which takes priority to U.S. Provisional Application No. 60/419,728, filed on Oct. 21, 2002, which is a continuation-in-part of U.S. Utility patent application Ser. No. 10/177,889, filed on Jun. 21, 2002, which takes priority to U.S. Provisional Application No. 60/299,864, filed on Jun. 21, 2001, the entire contents of each are incorporated herein by reference.

### BACKGROUND

1. Technical Field

The present disclosure generally relates to the field of 3-dimensional sonar and more particularly, to 3-dimensional forward-looking sonar with a fixed frame of reference.

2. Description of the Related Art

There are many types of sonar systems used for military, commercial, and recreational purposes. Generally, forward looking sonar systems are designed to build a 2-dimensional image along a single vertical or horizontal slice. More advanced systems are capable of building 3-dimensional images through a series of 2-dimensional pings pointed directly below the vessel with the direction of the 2-dimensional strip being perpendicular to the track of the vessel. This type of system is downward-looking and used for bottom mapping. At present, commercial forward-looking navigation sonars in creating a 3-dimensional image from a single ping, having any array geometry are unknown.

In the field of interferometry, arrays of many receivers are used, which enable a user or an autonomous system controller to make precise angular measurements for long-range detection, imaging, object classification, obstacle avoidance and the like. The operating frequencies can vary between a few Hz for seismic applications to many Megahertz or Gigahertz for ultrasound and radio systems. The sensors are usually arranged in an array in order to improve the signal to noise ratio for better detection. In such an array, the receiver hardware must be replicated for each channel. Since the number of array elements can vary from a minimum of four to several thousand, the cost for the receiver hardware can be a real burden. Furthermore, in order to perform the additional operations required for detection, for example: beam forming and multi-beam processing; each sensor output must be connected to a central signal processor. Depending on the number of array elements, this can create a serious wiring burden. Finally, since the sensors detect analog signals while the central processing unit operates in the digital domain, each channel must be equipped with a high-resolution analog-to-digital converter (ADC). The complexity of these systems limit the ability to provide for upgrades and modifications and render repairs expensive.

A modem sonar system has multiple, distinct subsystems including hardware, signal processing, and display technologies, which must be designed to work together. The purpose of such a system is to detect, localize and optionally classify a target as well as output that information for display and/or further automated processing such as but not limited to performing navigation operations, triggering alarms, or making volume measurements. In producing such a system, it is also important that electronics complexity, sensor channel count, and processor speed limitations as well as manufacturing and calibration requirements are considered in the overall system architecture and design. Many of the distinct subsystems can be thought of as black boxes and can operate somewhat independently of each other. However, when considered as a complete system, the aforementioned parameters can be optimized.

A forward looking or side looking or bottom looking sonar system includes, among others, the following features. A transmit transducer projects a signal into the water ahead of the vessel. A phased array of receiving sensors provides signals to a computer which determines the azimuthal and elevation angles of arrival and time of arrival of signals. The sonar system also includes tilt and roll sensors and may be interfaced with GPS and a compass. The acoustic signal information along with the tilt and roll can be processed to create a 3-D image ahead of the vessel with a fixed frame of reference relative to the earth from the raw beamformed data. This is necessary in understanding the picture ahead of the vessel. By including heading and GPS sensor information, the images can be fixed to a specific location on the earth. This is necessary for displays such as historical mapping and chart overlay. Advanced signal processing techniques enable the processor to extract targets from the raw beamformed data. Additional features of the system enable the suppression of many multipath targets.

### SUMMARY OF THE INVENTION

The invention submitted by the applicant includes detection techniques, array processing techniques, match filtering techniques, detection qualification techniques, multi-sensor coherent processing techniques, signal design and processing techniques for Doppler compensation and information display techniques.

Accordingly, a 3-dimensional sonar system having a fixed frame of reference including a transmitter and receiver array is disclosed. The system may include a single ping processor for processing received echoes from a single transmission including methods to match filter sonar sensor data, to optionally compensate for self Doppler, beamform sonar sensor data, to extract bottom targets from beamformed data and to extract in-water targets from the beamformed data. The system may also include a multi ping processor to operate on the outputs of multiple pings from the single ping processor including methods to detect tracks from in-water targets and methods to fuse information about bottom targets and/or in-water targets from multiple transmissions.

A graphical user interface display is also provided where the target detections are represented by icons whose color, size, coloring intensity, transparency, flashing rate, and/or decorations are dynamically determined as a function of target detection aging. The display may include one or more forms of ancillary navigation data that is oriented to the same fixed frame of reference as the sonar system, while ancillary data is displayed with the same frame of reference as the sonar data using the same coordinate axes.

The targets that are detected by the sonar may be referenced to a geographical location by way of geo-referencing where the ancillary navigation data is referenced to a geographical location and where the ancillary navigation data is displayed with the same geographical reference as the sonar data using the same coordinate axes. The ancillary data includes radar information from radar located aboard the same platform as the sonar where the orientation between the radar sensor and the sonar sensor is constant. The ancillary data may include nautical chart data, weather data, water current data, water temperature data, water salinity data, wind data, underwater bathymetric data, aerial photography data, 2-dimensional sonar imagery data, land topography data, other vessel location data, land map data or land topography data. Moreover, the ancillary data may include radar data, where the radar data has been referenced to a geographical location, and the radar sensor is not located aboard the same platform as the sonar.

Also disclosed is a multi ping sonar processing system configured to operate on the outputs of multiple pings from a single ping processor that includes methods to fuse information about bottom targets and/or in-water targets from multiple transmissions, where the single ping processor outputs are created by multiple 3-dimensional sonars with a common fixed frame of reference. The fused outputs of multiple pings from multiple single ping processors may also detect tracks from in-water target

### BRIEF DESCRIPTION OF THE DRAWINGS

The objects and features of the present disclosure, which are believed to be novel, are set forth with particularity in the appended claims. The present disclosure, both as to its organization and manner of operation, together with further objectives and advantages, may be best understood by reference to the following description, taken in connection with the accompanying drawings as set forth below:

FIG. 1 illustrates a block diagram of a signal processing chain;

FIG. 2 illustrates a depiction of volume of interest boundaries;

FIG. 3 illustrates a block diagram of a non-Fourier based beamformer approach;

FIG. 4 illustrates frequency relations;

FIG. 5 illustrates bandwidth relations;

FIG. 6 discloses a vertical beamformed data slice showing peak picking;

FIG. 7 is an illustration of azimuthal slice integration of peaks;

FIG. 8 illustrates a block diagram of multipath processing; and

FIG. 9 is an illustration of multipath data usage.

### DETAILED DESCRIPTION OF THE INVENTION

The present disclosure will be described in connection with certain preferred embodiments, with reference to the following illustrative figures so that it may be more fully understood. With reference to the figures, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. Specifically, this invention relates to sonar systems but can be applied to any phased array system such as phased array radar.

Within the context of the present disclosure, the following definitions are used for the terms listed below. It should be noted that some of these terms have other definitions when used in other contexts.

Beamformed Data: A partially processed form of received data which has been transformed from the hydrophone-time domain to the angle-time domain. The form of beamformed data is generally Signal Strength as a function of Horizontal (azimuth) Angle, Vertical (elevation) Angle, and Range (time). The transformation may be performed by means of a mathematical operation (such as Fourier based beamforming, non-Fourier based beamforming, or the physical characteristics of the receiver system (such as the case with a transducer whose directionality is a function of frequency).

Bottom: Another term for sea floor.

Bottom Target: A target that corresponds to a reflection source that is part of the sea floor (sea bottom).

Doppler Shift: The difference in frequency between a transmitted signal and its corresponding received echoes due to the relative motions between the transmitter and a reflecting target and a reflecting target and the receiver. The relative motion can consist of both motion of the target as well as motion of the transmitter and/or receiver.

Geo-Referenced: The characteristic of referencing a particular piece of data to a geo-graphical location or fixed frame of reference. Multiple pieces of geo-referenced information can be displayed in a single geographical display.

In-water Target: A target that corresponds to a reflection source that is not part of the sea floor. Generally, these targets are on the sea floor, in the water column or floating at the surface of the water with a small volume protruding under the water's surface.

Mills Cross: A phased array sensor consisting of two linear transducer arrays positioned orthogonally to each other where one array is used as a transmitter and the other as a receiver. The transmit signal is steered in one dimension by means of delaying the signal as a function of array element location and the received signals steered in the orthogonal direction by means of a beamformer. Through multiple transmissions, such a system can build a beamformed data set with 2-dimensional directivity.

Mills Cross Receiver: A phased array sensor consisting of a broad beam transmitter as well as a phased array receiver itself consisting of two linear transducer arrays positioned orthogonally to each other. In this system, the transmit signal is not generally steered and the received signals are steered in two dimensions by means of a 2-dimensional beamformer. With a single transmission, such a system can generate a beamformed data set with 2-dimensional directivity.

Ping: A transmission by an active sonar. This term may refer to the actual transmitted signal waveform, the echoes received by a sonar from a single transmission, the transmission process, or the entire transmission-echo-receiver cycle.

Sea Floor: Sand, silt, mud, rock or other material that make up the “ground” below the water. When used in the context of a target, the sea floor is generally made up of multiple reflecting sources of varying strengths, which when integrated together make up the surface of this object.

Self Doppler: The component of Doppler Shift caused by the motion of the sonar system.

Target: An object or signal reflection of an object within the detection volume of a sonar or radar which is within or could become within the detection capabilities of the sensor. This term may refer to the point location of an individual reflection source where the actual object may consist of multiple reflection sources.

Water Depth Ratio: Ratio of surface distance over depth below transducer. This ratio is often used in respect to describing operational limits of bottom detection for a particular sonar system.

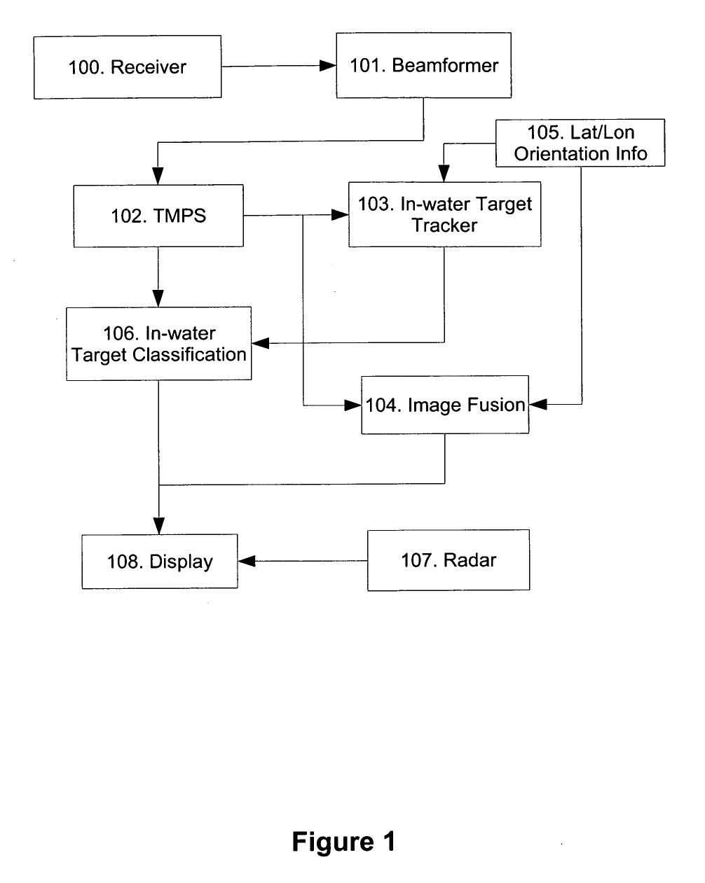

In a preferred embodiment, the present disclosure includes 3-dimensional forward-looking sonar with a fixed frame of reference. A block diagram of the signal processing chain for this sensor is shown in FIG. 1. The system begins with a receiver 100 capable of generating hydrophone information suitable for the creation of beamformed data with 2-dimensional directivity through various means. The beamformer 101 transforms the receiver data through various techniques, which may include Fourier based beamforming, non-Fourier based beamforming and/or frequency-steered acoustic beam forming, for example, as disclosed in U.S. Pat. No. 5,923,617, which is incorporated herein by reference in its entirety. It is important to note that in the preferred embodiment, the beamforming process can be any process suitable for generating beamformed data from hydrophone data. Specific embodiments of possible beamforming processes are disclosed later herein.

The beamformed data set along with transducer roll, pitch, and depth information is then used as an input to the Target Model Processing Stage (TMPS) 102. The TMPS is a post-beamformer processor, which is able to extract a variety of targets from the beamformed data set. One such TMPS approach has been previously disclosed in U.S. patent application Ser. No. 10/856,871. However, it is important to note that other such processing algorithms can be used for the TMPS, some of which are disclosed later in this specification as various embodiments of this invention. By lowering the thresholds of the TMPS, a larger number of false detections will be outputted from the TMPS along with additional, lower signal level actual targets. This higher output count may be advantageous for some types of downstream processing that can be added to the upstream processing as part of other embodiments of the present disclosure. The TMPS output includes targets that have been classified as either in-water targets or targets that are part of the sea floor.

The output of the TMPS can be sent to a user interface for display or to a machine interface for external use. However, further processing is possible with additional stages. Optionally, targets classified as in-water targets can be passed to a Target Tracker 103, which detects in-water target tracks based on the targets' relative locations. The Target Tracker optionally takes in information about the sensor's geo-referenced location and bearing orientation from external latitude/longitude and bearing orientation sensors 105. In such an embodiment the tracker can operate on the geo-referenced locations of the in-water targets rather than just relative locations. This improves target tracking because absolute information about a target's track can be calculated rather than just relative information. Once geo-referencing is enabled, the Target Tracker can optionally operate on TMPS output from multiple sonar sensors. Further details about target tracking capabilities related to various embodiments of the invention are described later in the specification.

In a further variation of the invention, the outputs of either the Target Tracker or the TMPS can be used as inputs to a Target Classifier 106 designed to classify in-water targets. The purpose of the Target Classifier is to classify detected targets as particular objects. For example in some applications, it can be advantageous to determine if the in-water target is a buoy, fish, mammal, diver, wake, or other object. The Target Classifier can utilize one or more classification domains including but not limited to geometric, spatial, active spectral, and temporal. A further classification technique which utilizes active as well as passive sonar is disclosed later in the specification.

Further processing can also be applied to the bottom target output of the TMPS. This processing relates to the fusion of bottom data 104 from multiple transmissions. Some aspects of data fusion can also be applied to in-water targets. A limited number of data fusion techniques are described later in the specification. However, it is important to note that these are only a few of the many embodiments of the invention, where the basic embodiment invention generally applies to multi-ping data fusion of any kind. It should also be noted that said data fusion can be applied to a single sensor or a plurality of sensors any number of which may be stationary or moving. In the cases of multiple sensors or moving sensors, a means of determining sensor geo-referenced position and orientation 105 is required. Additionally, various image fusion techniques may also be applied to in-water targets and the output of such may also be used as inputs to in-water target tracking routines.

In a preferred embodiment, a display of processed data 108 can be configured to portray the output of various processing stages. For example, beamformed data output from the beamformer 101 can be displayed as well as outputs from the TMPS 102. The display can also be configured to display track output from the in-water Target Tracker and the output of the Data Fusion stage. The display can be configured to represent any of these data outputs individually or combined in a single image. It may also be configured to include the display of externally compiled information that has been oriented to the same fixed frame of reference as the sonar data. These external data types may include, but are not limited to, navigational chart, radar, aerial photography, weather, bathymetry, or other data. Further details relating to specific variations of the invention's embodiment are described later in this specification. In yet another embodiment of the present disclosure, processed data from one or more of the various stages may be output to a data recorder, data base, machine interface or other non human readable display.

The preceding descriptions related to general embodiments of the present disclosure. However, many variations on these embodiments exist. The following descriptions relate to some of these specific variations.

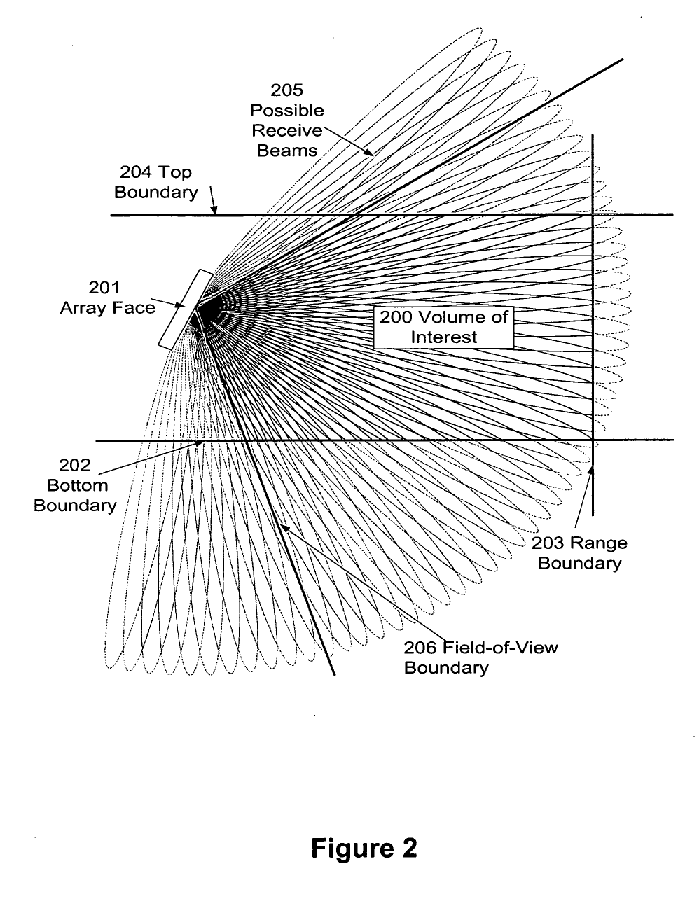

The beamformer stage of the disclosed invention can consist of a traditional Fourier based beamformer as known in the art. However, there are a number of unique variations which are included in the invention, which can be used as part of alternate embodiments. One variation relates to reducing the number calculations necessary for a given ping. In U.S. patent application Ser. No. 10/688,034, the applicant has previously stated that it may be advantageous to limit the transformation to time-angle locations that correspond to Cartesian locations (x, y, z; down range, cross range, depth; etc), which are within some geometric bounds. These geometric bounds limit the Beamformer's Volume of Interest as illustrated in FIG. 2. This Volume of Interest 200 was described to be limited by the Bottom Boundary 202, the Range Boundary 203, the Top Boundary 204, and the Field of View Boundary 206. These boundaries were developed in order to limit the Beamformer's number of Possible Receive Beams 205 and the ranges at which they are calculated. The Volume of Interest defines the limited locations at which the transformation is performed. Such an approach is particularly useful in reducing the total amount of computations as compared to performing the transformation at all time-angle combinations possible for a given beamformer or angle estimation algorithm. The preferred embodiment of the invention disclosed in this specification includes the ability to limit beamformer processing to a Volume of Interest by the means described above and as disclosed in U.S. application Ser. No. 10/688,034.

One variation of the invention includes an additional method of finding limiting boundaries. This method utilizes external inputs such as echo sounder or digital chart information. In this method, information about the expected depth of the sea floor can be ascertained from external systems. Rather than beamforming to a set Bottom Boundary 202, this embodiment of the invention beamforms to a depth equal to the independent depth estimate multiplied by some factor. This factor is used to allow for changes in bottom depth that are within the Volume of Interest. In cases where the sea floor is very shallow, this may reduce the number of locations for consideration in the calculations for a reduced processing load.

Another variation on the preferred embodiment relates to the selection of ranges at which beamforming is performed. The computation load on the processor due to beamforming is high when compared to many other processing tasks; particularly if angle resolution is fine and the field-of-view is large, as is the case with most 2-dimensional or 3-dimensional systems. One way to reduce beamforming computational load is to only beamform ranges at which targets are present. For the purpose of this specification, this technique shall hereby be referred to as Range Gated Beamforming.

In range gated beamforming, the received signals are only beamformed at ranges where a target is detected in the beamformer input signals. These input signals are the receiver transducer waveforms. To enhance detections in the receiver signals, the signals may optionally be match filtered using standard match filtering techniques. Specifically, these techniques include, but are not limited to FIR filtering or spectral template matching. In the case of FIR filtering, the time reversed complex conjugate of the expected or transmitted signal are used as the FIR weighting inputs. At times where the filter's output has a large signal, a target is detected. In the case of spectral template matching, the spectrum of the received signal as it varies over time is compared to the spectral pattern of the transmitted or expected signal over time. At times where the spectral template has a strong match with the received signal, a target is detected. In both cases, the expected signal may be shifted up or down in frequency due to Doppler shifts in the received signal.

Yet another optional feature of the invention is angle gated beamforming. In this embodiment, a Fourier based beamformer is used as a rough angle estimator. Then a higher resolution non-Fourier based beamformer can be used to determine if the return is actually from multiple targets closely spaced in angle and/or determine a more exact angle to the target. In this case, the non-Fourier based beamformer would only search angles that are near the center of the Fourier based beamformer's detected targets as selected by a processor configured to detection possible targets in a beamformed data set. For example, see the non-Fourier based beamforming disclosure of U.S. patent application Ser. No. 10/862,342.

Additionally, U.S. patent application Ser. No. 10/862,342 discloses the ability to limit the solution space of non-Fourier based beamforming to a limited number of angles using what it described as a “beamspace” implementation. The specification also notes that the model based beamformer can utilize a priori information that might be available from a Fourier based beamformer. However, the previously disclosed invention does not state how the extents of the beamspace implementation selected or how said a priori information should be used. Specifically, one embodiment of the new invention disclosed in the present specification utilizes a processor configured to detect possible targets within a beamformed data set, select a range of beamspace angles about said possible targets, and use said selected range of angles as the limits in a beamspace implementation of a non-Fourier based beamformer. The advantage of range gated beamforming when applied to non-Fourier based beamforming is that the number of computation involved with non-Fourier based beamforming is reduced since the solution space has been reduced from all possible angles to just those selected by the processor. This technique can be utilized with a fully populated receive array in a planar, curved, or other conformal orientation or with a partially populated array with receive transducers oriented as a Mills Cross Receiver as previously disclosed in U.S. patent application Ser. No. 10/177,889, which is incorporated by reference in its entirety.

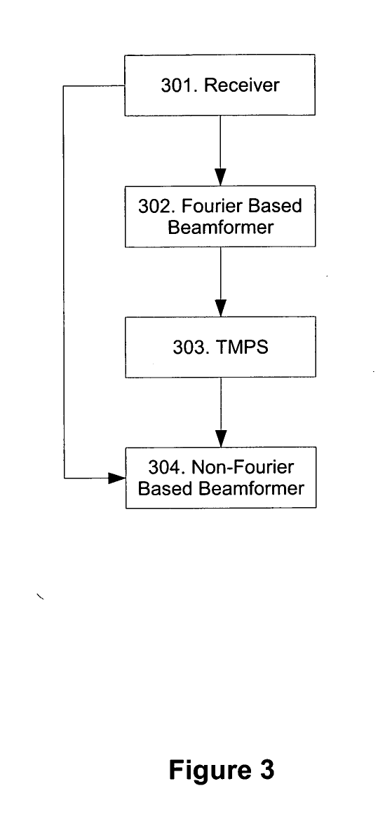

A further optional embodiment of the invention relates to the estimation of the number of targets present in the snapshot matrix of a non-Fourier based beamformer. Such estimation is a required component of non-Fourier based beamformers as described in U.S. patent application Ser. No. 10/862,342. One solution previously provided includes the use of an Adaptive Target Population Estimator (ATPE) which utilizes various techniques including “ranking and winnowing” to estimate the number of targets present at a given range and/or beamspace. An improvement upon this process is proposed as one embodiment of the new invention disclosed in the present specification. In this embodiment, the number of possible targets as detected by a TMPS operating on a beamformed data set produced by a Fourier based beamformer is used as an estimate of the number of targets to be used as part of a non-Fourier based beamformer which operates on the same receiver data set as the Fourier based beamformer. The number of targets estimated by the TMPS can be used in place of the ATPE or weighted with results from the ATPE to improve the estimate of the actual number of targets as required by the non-Fourier based beamformer. A block diagram of this processing flow is shown in FIG. 3.

When the various embodiments of the invention are used aboard vehicles traveling at high speed, the received signals are Doppler shifted echoes of the transmitted signal. For a given transmitted signal were the beam pattern of the transmitter is aligned with the direction of platform motion the resulting frequency shift due to Doppler effects varies as a function of azimuth and elevation angle relative the direction of motion since only the component of the direction vector aligned with the platform motion direction causes a Doppler shift. For example, an echo signal returning from a direction vector 45 degrees to the side and 45 degrees down from the direction of platform motion will have ½ the Doppler shift of an echo returning from a direction aligned with the platform's motion. There are multiple methods by which the system can be configured to compensate for these effects. Optionally, these methods can be implemented in various embodiments of the invention to improve system performance when Doppler shifts are present.

One embodiment's method is to utilize a signal that has enough Doppler tolerance to be effectively matched with a matched filter regardless of the angle up to a maximum platform speed. This allows for a single match filter regardless of platform speed or look direction and enables match filtering to be applied to the hydrophone time series or beam time series. For example if there is Doppler shift of S hz at a given speed in the direction of platform motion, then the waveform must have a Doppler tolerance of at least S hz to mitigate poor match filtering effects.

Most systems have a limited set of look directions. If the maxim Doppler shift for a given speed is outside of the Doppler tolerance for a given transmit signal but the range of Doppler shift at all look directions of interest is still within the Doppler tolerance of the signal, the transmitted signal can be shifted lower in frequency by the expected Doppler shift. This removes the need to change the match filtering based upon speed. This is known as Self Doppler Removal Signal Shifting and is another method that can be applied to an embodiment of the invention. Yet, another option is to modify the match filter to operate at a higher center frequency. This may or may not be advantageous depending upon the system's overall design.

If the range of Doppler shifts for all look directions of interest is greater than the Doppler tolerance of the signal, then multiple match filters are needed, varying by look direction to ensure that the Doppler shift at a particular look direction can be appropriately processed. This more computationally intensive that a single match filter for all look directions.

Clearly, it is advantageous to employ a single match filter regardless platform speed. From this, one can conclude that this is most easily achieved be utilizing a signal with high Doppler tolerance. One method for generating a signal with high Doppler tolerance which can be employed by various embodiments of the invention is the following:

1. Determine the maximum Doppler expected (hzDop).

2. Determine the maximum bandwidth (BW) available with a center frequency of fc_bw where the bandwidth is in the range of fc_bw−BW/2 to fc_bw+BW/2.

3. Build a signal with a frequency sweep from fc_bw−BW/2+hzBuf to fc_bw+BW/2−hzDop−hzBuf where hzBuf is a buffer from the edge of the system's bandwidth used to compensate for edge effects.

4. Optionally, bandpass filter the swept signal with a band pass filter with a first stop band frequency of fc_bw−BW/2, first pass band frequency of fc_bw−BW/2+hzBuf, a second pass band frequency of fc_bw+BW/2−hzDop−hzBuf, and a second stop band frequency of fc_bw+BW/2−hzDop.

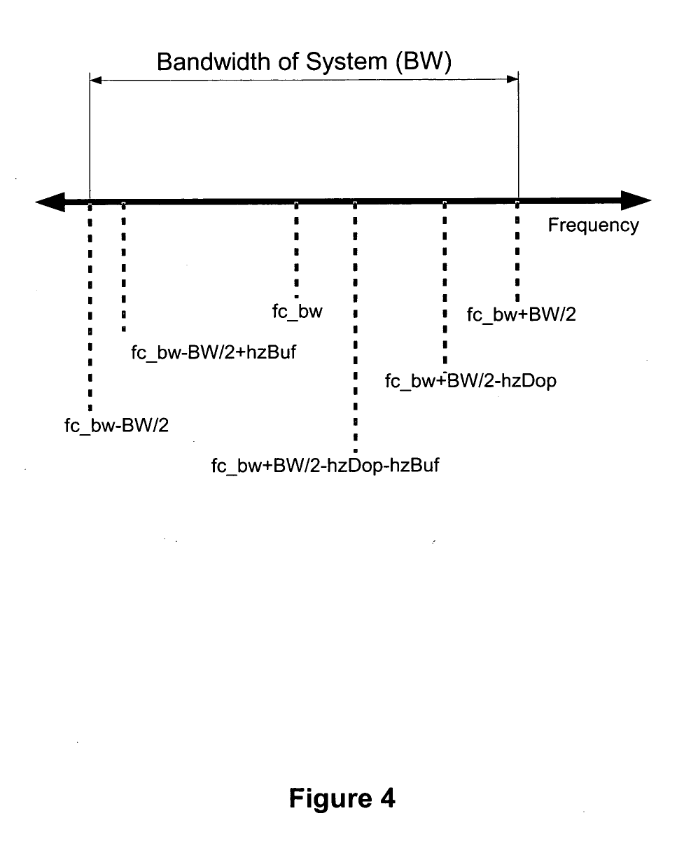

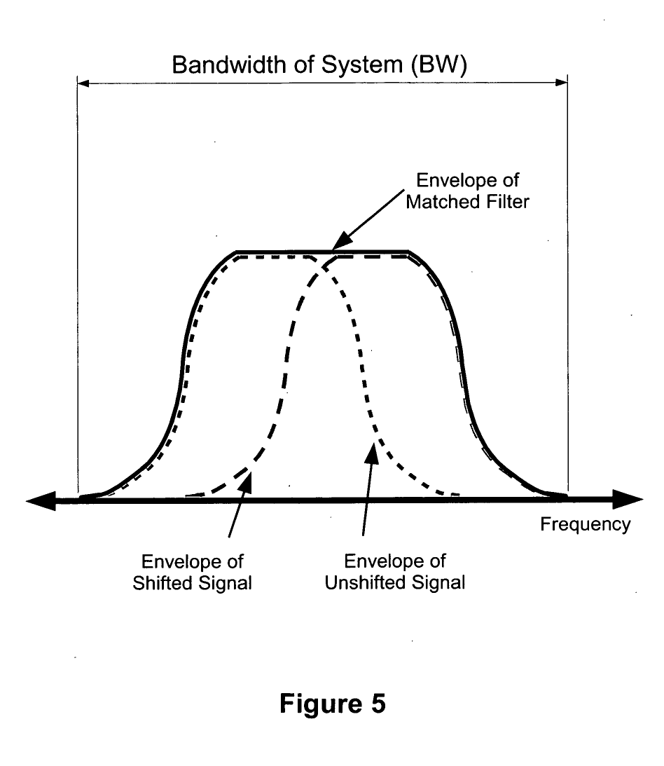

FIG. 4 shows the relative values of these various frequencies. The corresponding match filter can then be built for a signal with the same characteristics as the transmitted signal but with hzDop=0. When the match filter is applied to the received signal with any Doppler shift between 0 and hzDop, the autocorrelation will have approximately the same output amplitude. This allows for a system which has a single match filter regardless of look angle and platform speed. In systems where there is a tremendous amount of maximum Doppler shift relative to the system's bandwidth, this Doppler tolerant signal approach can be combined with the afore mentioned Self Doppler Removal Signal Shifting technique. FIG. 5 shows the relation of the unshifted and shifted signals relative to the system bandwidth.

The value of the information from a 3D forward looking sonar with a fixed frame of reference is independent of how that information is generated. Previously, the applicant disclosed a sonar where the receiver has directivity in 2 dimensions and the directivity is derived from having transducers located appropriately to perform beamforming in 2 dimensions. This produces a data set of signal strength bins indexed by vertical angle, horizontal angle and range from N×M channels (for a fully populated receive array) and N+M channels for a sonar utilizing a Mills Cross Receiver configuration.

Another way of generating such a three dimensional data set of signal strength bins is by utilizing transducers that have directionality based upon frequency as described by Thompson in U.S. Pat. No. 5,923,617. Such transducers can in theory be designed such that a unique 2D look direction consisting of a horizontal and a vertical angle component is associated with a single frequency band. However, in practice, this technique can only be achieved with unique 1D look directions, thereby replicating the angle by range information produced by a common 2D multibeam sonar with a single electronics channel. One embodiment of the invention disclosed by the applicant overcomes this practical limitation by utilizing an array of such frequency dependent transducers aligned in a linear fashion such that the frequency controlled look directions are perpendicular to the axis of the array. This allows for traditional beamforming to produce look directions orthogonal to frequency defined look directions, thus creating a 3D data set utilizing N electronics channels rather than N×M or N+M channels.

As part of the preferred embodiment's processing chain, beamformed data is produced which is passed as input to the TMPS. The TMPS is used to extract potential targets from the beamformed data set. These targets include the following information: absolute range, azimuthal angle, and elevation angle all relative to the sensor as well as echo signal strength for that bin location. When combined with information about the transducer's roll and pitch orientation, surface range, bearing, and depth to the target relative to the sensor can be calculated using simple geometry and trigonometry. Additionally, given information about the sensor's depth below the surface, the absolute depth of the target can also be calculated. The preferred embodiment generally includes the use of a TMPS regardless of the actual algorithms employed by that processing stage. In a specific embodiment, the TMPS may include the algorithms originally disclosed by the applicant in U.S. patent application Ser. Nos. 10/856,871 and 10/688,034. Additionally, another embodiment of the invention relates to an improvement which can be applied to both the afore mentioned TMPS approaches as well as other possible TMPS algorithms.

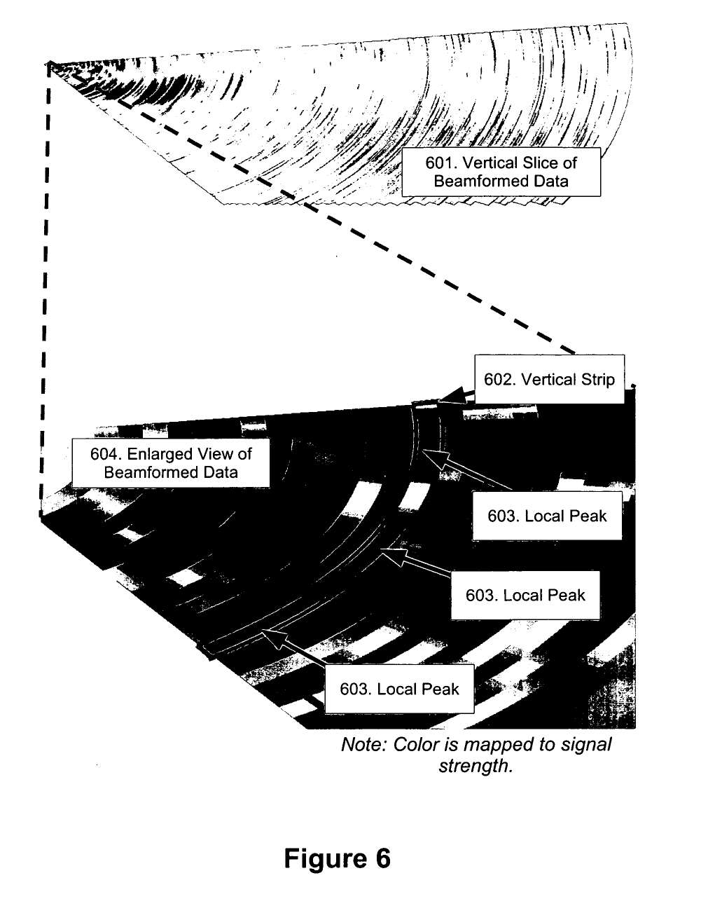

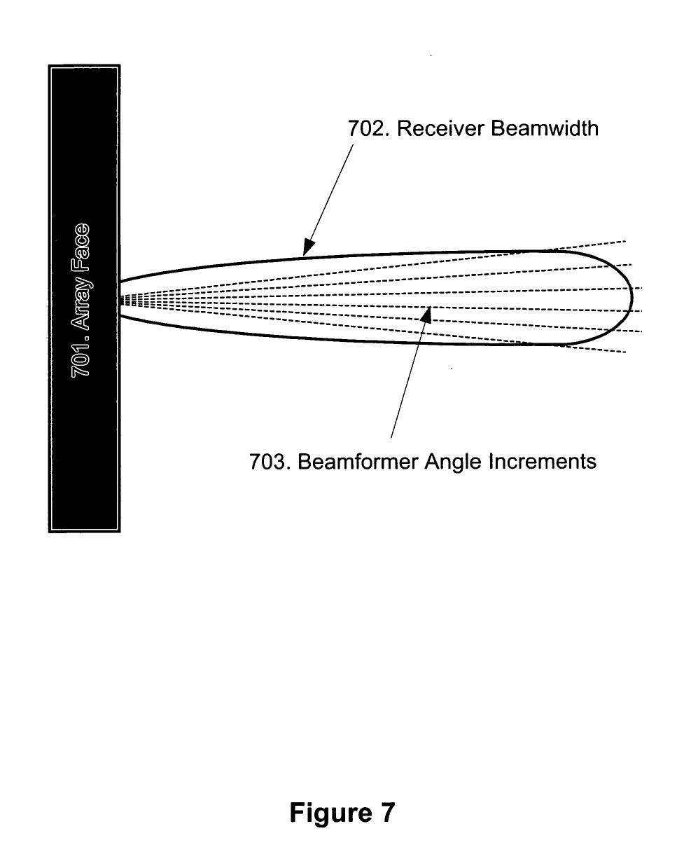

All embodiments of the invention utilize a beamformer to generate beamformed data from the receiver data. This beamformer may be configured to create a beamformed data set with arbitrary angle spacing any of which can be input into the algorithms disclosed in U.S. patent application Ser. Nos. 10/856,871 and 10/688,034. Both of these algorithms perform local signal strength peak picking of the beamformed data set along the vertical (elevation) angle dimension for every given absolute range and horizontal (azimuthal) bearing of interest as illustrated in FIG. 6. One limitation of the previously disclosed inventions is that the beamformer produces a value at a given point location in space where in reality, the resolution of the sensor has a finite beamwidth. This means that return signals corresponding to a specific target are spread across the entire beamwidth not just along the line generated by the beamformer which corresponds to a particular look angle. The practical result of this is that when searching for bottom targets, the local peaks corresponding to bottom targets may not be easily detected. One embodiment of the presently disclosed invention offers an improvement to bottom detection algorithms. In this embodiment, the algorithmic components of the TMPS dedicated to bottom detection are applied to the local peaks detected at a variety of azimuthal angles when the extent of those angles corresponds roughly to the beamwidth of the sensor. Ideally, the entire beamwidth should be integrated together. However, in practice the beamformer can only beamform to a finite number of angles. In this case, it is preferred that the angle increments are as small as possible and smaller than the system's resolution. For example, if the beamformed data is spaced at 1 degree intervals in azimuth and the azimuthal resolution of the sensor is 10 degrees, then the bottom detection algorithms are applied to the peaks detected within +/−5 degrees of the desired azimuthal look direction. This concept is illustrated in FIG. 7.

Another embodiment variation pertaining to this same subject performs local peak picking where the peaks may be in localize in azimuthal and/or range in addition to elevation. Where TMPS algorithms allow, all peaks can be considered in the bottom detection processing. Where TMPS algorithms require a single possible bottom peak at a given absolute range and more than one peak was detected at a given absolute range due to the presence of a peak in more than one azimuthal direction, the peak with the maximum signal level, the mean or medium location of the peaks, or the location corresponding to a curve fit to the peaks may be used in the bottom detection algorithm. The concept of searching for peaks across multiple azimuthal angles can be summarized as follows:

When looking for the sea bottom, beamform in horizontal at an angle spacing greater than the beam resolution of the receive array. Then perform local peak picking of the beamformed data set. Peak picking is process of finding a local maximum in the signal strength domain in the horizontal angle index, vertical angle index, and range index axes. This peak picking can be 1D, 2D, or 3D. 1D peak picking can be along the vertical angle axis at a single horizontal angle index and at a single range. 2D peak picking can be along the vertical and range axes at a given single horizontal angle index. 3D peak picking is along the vertical, horizontal, and range axes. The next step is to identify a bottom along a given horizontal (azimuthal) angle. For a given horizontal angle, the peaks from a plurality of horizontal angles centered upon the said given angle where the extent of the angles is bounded by the beamwidth of the array are merged into a 2D plane by utilizing their positioning information of surface range (or absolute range) and depth and assuming that horizontal angle is the said given center angle regardless of which actual angle index is used. These peaks can be considered pre-detections for bottom fitting. From the merged data set of pre-detections, a bottom can be detected by searching for curves or other features in range/depth space. Curve detection can be performed using a variety of techniques common to image processing. Some of these techniques may utilize weighting to smooth or fit curves. Factors such as signal strength, distance from transducer, 1D, 2D, or 3D peak type and water depth ratio can be used for weighting. This process is repeated for every azimuthal angle of in the Volume of Interest.

Multipath reflections are often considered a leading cause of problems and errors when creating images with forward looking sonar systems. By generating forward looking sonar information including depth it has been shown by the applicant in U.S. patent application Ser. No. 10/688,034 that the effects of multipath reflections can be mitigated. If the transducer depth is well known, multipath returns which to originate from above the sea surface can be included in the feature detection process by mirroring the multipath returns about the sea surface. In yet another embodiment of the invention disclosed in this specification describes a processing technique that can be used with forward looking sonar systems which provide depth information where multipath information is used to enhance mapping capability and image quality for use in sonar applications including but not limited to user displays, advanced data processing and classification, and navigation systems.

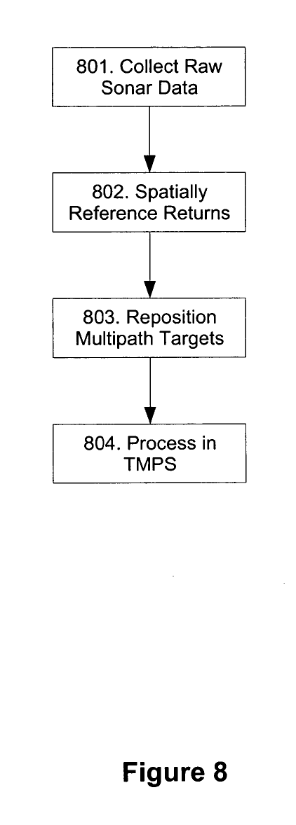

A top level diagram of the process flow for the preferred embodiment is shown in FIG. 8. First, the forward looking sonar data should be collected using one or many of the various forward looking sonar techniques know commonly known in the art 801. The collected raw sonar data is then processed using common sonar processing techniques which can include but are not limited to bandpass filtering, comb filtering, decimation, Doppler shift compensation, matched filtering and beamforming in order to provide a processed output of spatially referenced signal strength or target correlation information 802. Next, possible targets that are detected to be multipath reflections should be repositioned to their original reflector locations 803. Lastly, the repositioned information is processed normally as part of a TMPS 804. In the preferred embodiment, the multipath signals of interest are generated by reflections off of the sea surface and the following descriptions are based upon these surface reflected multipath signals. However, this approach is not limited to sea surface reflection and these same techniques can be applied to other surfaces of known orientation which create multipath reflections.

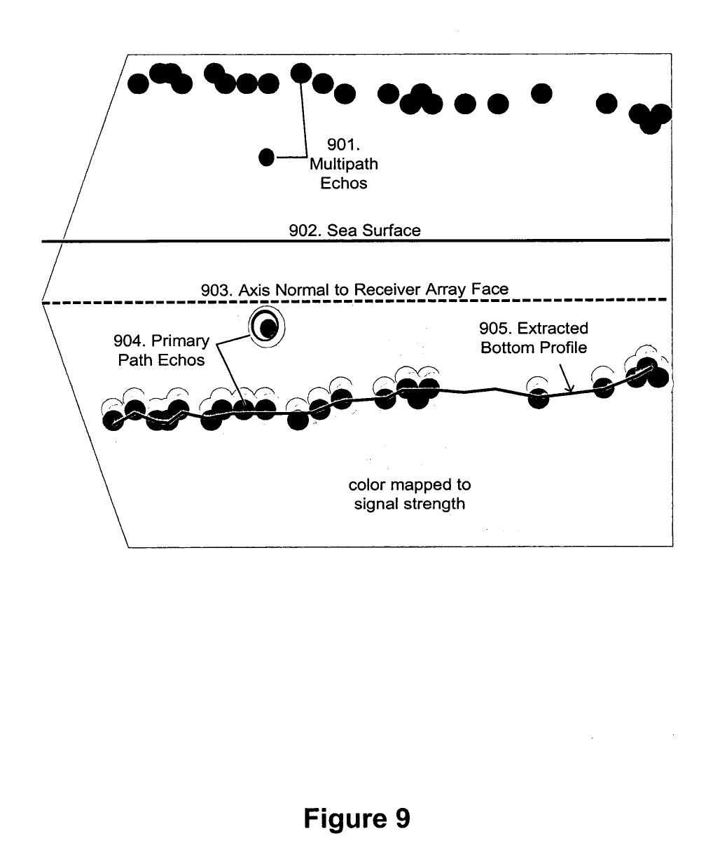

In the preferred embodiment, a forward looking sonar system capable of providing depth information should be mounted so that the vertical field-of-view includes the sea surface and any desired in-water or bottom target as shown in FIG. 9. Roll, pitch, heave, and yaw stabilization should be included as part of the preferred embodiment as needed to ensure the desired field-of-view. For optimal performance, the array face orientation must be known relative to the sea surface including transducer depth below the surface and the transducer roll and tilt for a given time sample of raw sonar data.

One way of detecting multipath reflections 901 is by detecting targets above the sea surface. These targets are in many cases multipath reflections. However, they should be filtered for noise, sidelobes, and other such false targets as is normally done to primary path signal returns 904. As part of this filtering process, various embodiments of the invention may include ignoring or negatively weighting the returns from within the volume of water near the air/water interface to account various artifacts such as but not limited to bubbles, waves, and errors in spatially referencing the array. In many cases, the multipath signals are mirrored reflections of the primary reflectors. First order approximations of the primary reflector location can be done by simply spatially mirroring the multipath signal about the air/water interface axis 902. Higher order approximations include but are not limited to various absolute distance measurement and placement algorithms. In the preferred embodiment, the most appropriate order location approximation should be used in order to minimize primary target placement errors relative to other placement errors created by imperfections and resolution limitations from other parts of the entire sonar system. Additionally, in the preferred embodiment, only the first multipath reflection is used in enhancement processing. The first multipath reflection can be identified through various commonly known classification techniques, the simplest technique being simply choosing only the loudest echo signal from the multipath volume. Multipath reflections created by more than one bounce can also be used with the following image enhancement techniques, as required by the application of the preferred embodiment in actual systems.

In the preferred embodiment, additional filtering efforts may be employed to select a subset or series of subsets of multipath reflections from the original group of identified multipath signals. This filtering effort may employed by but not limited to filters which use edge tracing, grouping, group sizing, target strength, and/or other common signal properties as inputs.

After detecting the presence of multipath signals, the preferred embodiment utilizes the multipath signals in extracting and/or detecting bottom or in-water targets from the beamformed data by including the detections of the re-positioned multipath targets in the TMPS target extraction and detection algorithms. This is done by first identifying the primary reflector location of the multipath signals as described above. Then, artificial “targets” consisting of the calculated primary reflector location and multipath spectral signal information are created. These “artificial” targets are called Multipath Adjusted Targets (MATs). In the preferred embodiment, MATs along with conventional primary reflector target information are used as inputs to any further image processing techniques (such as a TMPS) know in the art which may be applied to the beamformed data. These further processing techniques may employ weighted filtering of MATs in order to best integrate the MATs data into the data flow. The preferred embodiment, may also include one or more of the following advanced weighting techniques that unique to MATs data:

1. In cases where both MATs and conventional target information are available for a given absolute range only the target with the largest target strength is accepted.

2. In cases where MATs or groups of MATs are located spatially near conventional targets or groups of conventional targets, only the shallowest targets are accepted.

3. In cases where groups of MATs and groups of conventional targets are located near each other, group shape, group density, group size, group depth, average group target strength, group target strength variation, or other common image/sonar characterizing features may be used either singularly or in combination to determine which targets are used as defined by the particular application of the preferred embodiment.

4. In cases where both MATs and conventional targets are interspersed with each other, both types of targets may be treated equally.

In many underwater environments, various in-water elements along with beam interaction and constructive and destructive interference cause gaps of low signal in the beamformed data. This invention of utilizing multipath information can, in many cases, fill in those gaps because the effects causing the gaps is not always present in the multipath signals.

Image fusion is another important aspect for various embodiments of the invention. For the purposes of this specification, image fusion is the process by which information from multiple transmissions are combined into one image or overall data set, where the multiple transmissions may originate from a single 3-dimensional sonar sensor or from multiple 3-dimensional sensors located in spatially disperse locations. Any or all of these sensors may or may not be moving.

Such image fusion techniques are intended to address one or more of the following:

1. Combining returns from the sea-floor.

2. Combining returns from in-water targets.

3. Displaying information to the end used.

In the first case, there are multiple approaches which may be used as part of this invention. One approach is to simply display the sea floor as detected by a single transmission in a geo referenced display with bottom estimates generated by the latest transmissions replacing the bottom estimates of past transmissions where the coverage areas overlap. Another approach is to fit a surface through all points that have been detected as part of the sea floor and designate this surface as the overall bottom map whereby the bottom map is updated in a timely manner relative to the transmission rate of the individual sensor or sensors. Yet another approach is to fit a surface to all the points from multiple transmissions that would normally be used to generate a single ping bottom image. In these last two approaches, bottom point characteristics such as signal-to-noise ratio, distance from sensor, age, and sensor resolution may be used a weights when fitting the bottom surface to the data points.

In the second case, in-water targets may be displayed in a geo-referenced display where representation of the in-water target is a function of the age of the in-water detection. For example, in-water targets from older detections may be displayed as smaller icons, may be removed from display, and/or may be displayed in different color or transparency. Additionally, another aspect of the invention is that track information from a processor configured to detect target tracks can be displayed in this same geo-referenced environment.

In the third case, the information may be displayed to the user in the afore mentioned ways. In addition, it may be advantageous to highlight to the user which part of the overall image is being updated from the new information generated on each ping. One way of showing this is highlighting the range and angle markers which represent the extents of an individual transmission within the display. The display may optionally show an icon representing the sensors' static or dynamic locations in the afore mentioned geo-referenced environment. This highlighting of sensor extents can be applied to a system that is not geo-referenced but does consist of multiple volumes of interest generated by one or more sensors over one or more pings that are all referenced to the same fixed frame of reference. The reference may by a ship, transducer or component of the sensor or sensor platform whose position is known relative to the sensor.

The output of the processing routines operating upon a single transmission as described in U.S. patent application Ser. No. 10/856,871 can also be used as the input to multi-ping target tracking processing. This is particularly relevant to in-water targets which are things which may move over time. For example, given a series if pings, each with an in-water target which has been detected, localized, and determined to be within a certain time-range-bearing variance relative to preceding and following transmissions, a target tracking algorithm can determine that the series of in-water target detections form a track. From this track, a processor can determine the heading and speed of the target as well as estimate the future location, heading and speed of the target based upon the track's history. Such information about a target can be used to improve understanding about the target. This can be considered a low level classification (i.e., moving target, non-moving target, fast moving target, slow moving target, etc). One embodiment of the invention includes such target tracking techniques and processor.

Once a track is detected by the processor, the track information can be used in a variety of ways such as but not limited to input for a higher level classifier, displayed on a user interface, or input for a collision alarm. On example of the first case is speed and track information may be used to classify a target as a possible threat or non-threat in a swimmer detection sonar. A target moving at a high speed cannot be a swimmer, but a target at a slow speed may be a swimmer and requires further classification features to be determined to be a threat or non-threat.

One example of the second case is a line or curve representing the track history may be displayed on a screen as part of a user interface. Another example is a text output which may also be included which displays the heading, speed and location of a the target. A further example is a target may be displayed differently based on its heading or speed information. One embodiment of this example is fast moving targets may be displayed more brightly than slower moving targets, may be represented by a different icon or icon size, may blink, and may include a graphical decoration such as a halo, ring, or other icon augmentation. Another embodiment may include only displaying in-water targets that have tracks with particular characteristics such as minimum track length, minimum/maximum speed, etc. Either embodiment may be displayed in a 2 dimensional or 3-dimensional environment with a view that is stationary to the sensor, sensor platform or geographical location. This display may include tracks and/or in-water targets displayed on top of a digital chart, aerial photography, bathymetry, or radar images. In all cases, one or more tracks may be displayed simultaneously.

One example of the third case is a processor may examine the tracks of detected targets and compare them with the track of the sonar's installation platform and provide notification if a possible collision is detected. This notification could be in the form of an audible or visual alarm in embodiments where a human interface is appropriate. In other embodiments, the notification may trigger a navigation change via a machine interface to the control system of the platform aboard which the sonar is installed. In yet another embodiment, the collision alert may be sent to one or more of the in-water targets assuming that they are cooperative targets which can be controlled or receive navigation commands remotely.

Another aspect of the invention included in some embodiments relates to the afore mentioned collision notification. Included in this embodiment is a processor which is configured to operate on processed or partially processed data and to provide automated navigation suggestions to the user or machine interface based upon the track information and the sensor or sensor platform's position, speed, heading, and/or predicted track where such suggestions could include but are not limited to:

1. Notification of a collision course with a moving or unmoving object detected by the sonar or some other sensor.

2. Suggest altering course (port, starboard, ascend, dive, or a combination thereof) based on directions that have the least density of objects, based on opposite direction as that of highest object density, and/or predefined navigation biases such as towards or away from other objects or features detected by other means such as radar, AIS, or charts.

3. Suggest slowing or increasing speed in order to avoid collision with a moving object.

Such navigation suggestions could be translated into autopilot commands and interfaced to a ship-board or remote auto pilot system and or exported for display on external navigation display systems.

The spatial classification routines included in the TMPS and the optional target tracking information produced by the Target Tracker provide some amount of information about a particular target and can be considered low level classifiers. Clearly, in any sort of detection or imaging system it can be advantageous to classify the detected targets. For example, in many types of navigation and security sonars is often important to be able to separate the sea floor from in-water targets as well as classify in-water targets as some particular type of target. Simply, looking at the acoustic target strength of a target is not always enough to discern its identity. Many active sonars add basic classification capabilities through image processing techniques in an effort improve system performance. For example, 2-dimensional geometric image processing techniques can be applied to 2-dimensional sonar images such as those produced by typical sidescan or scanning sonars. Some active sonars include active spectral processing whereby the classification software attempts to classify the type of material of a target based upon spectral differences between the transmitted signal and the reflected sound. The applicants themselves have disclosed a system where spatial information from the returned echoes are used to classify targets into classes consisting of the sea-floor and in-water targets based upon the relative locations of the targets detected with an active sonar system.

All of the above mentioned techniques rely on information derived from an active sonar signal and all of the above techniques have their own limitations. For example, geometrical image processing is feasible when system's resolution is high relative to the object size. The outline of a large shipwreck can be imaged in a 2-dimensional sonar at reasonable ranges and image processing techniques can often discern the difference between the ship and the rest of the non-ship objects detected in the image. However, that same system cannot easily image a swimmer, dolphin, or seal at those same ranges and discern between man and beast. A 3-dimensional sonar can detect a target floating in the water column and classify it as not part of the sea floor. However, it may have difficulty again in discerning between a swimmer and sea mammal. A wide band sonar may be able to distinguish the difference between the swimmer and the sea mammal, but due to practical limitations in implementing such a system, it is difficult if not impossible to develop a wide band multibeam sonar suitable for wide coverage volumes and fast updates (both of which are generally requirements for some types of navigation and security sonar systems). Clearly, there is a need to mitigate the limitations of existing active classification techniques.

In addition to active sonars, there is another class of systems which only operate in passive mode. That is to say, they do not transmit a sound for use in echo location and imaging. Rather, these passive systems only listen to the sounds found in the environment. Passive systems are often used to detect mammal vocalizations, explosions, ship mechanical sounds and other sounds generated by things within the marine environment. Though not all things generate their own sounds all the time, when sounds are produced, these sounds are often very distinct and can be used to classify the object as a particular thing such as sub-sea landslide, motor boat, mammal vocalization, etc. The drawbacks of only using passive systems for detection, localization, tracking, and classification are the following:

1. Targets can only be detected if they make a sounds. Not all targets produce sounds all the time.

2. Localization requires signal detection on multiple receive devices in spatially diverse locations all of which require a high level of time synchronization. Due to the physics of acoustic triangulation, large spatial diversity is usually needed which is not always practical or possible.

3. Passive tracking requires multiple passive localizations within a small enough time-space window to reliably join localizations into a track. Given the non-continuous nature of many passive signals, this is not always feasible.

4. Classification from passive signals is only possible with targets that generate sounds, such as mammals, ships, etc.

The applicants submit that these limitations can greatly be mitigated by integration of active and passive sonar systems working in conjunction. In one embodiment, the applicants disclose the use of an active sonar system to detect, localize and track targets. These three tasks are generally considered readily achievable using both traditional active sonars as well as the 3-dimensional sonar with fixed frame of reference previously disclosed by the applicants. Additionally, in this same embodiment, a passive sonar subsystem is integrated into the active system. Preferably, the passive system is capable of beam steering or direction finding so that it can listen in a direction defined by another part of the overall system. The active system is used to detect, localize and track in-water targets. From the track information, a controller sub-system is configured to extract the time-direction series from the passive system which corresponds to passive acoustic signatures acquired from points along the active track. In this way, the passive system is able to listen along the active track and a passive classifier can be used to detect and classify sounds emitted from the target. Since the passive data set can be closely gated to correspond to target time-locations as determined by the active tracks, information from the two subsystems can be combined allowing for a classification in the passive domain to identify a tracked target which had been detected, localized, and tracked in the active domain.

The afore disclosed aspects of the invention generally relate to detection and processing techniques. The following relates to display and visualization of data produced by various embodiments of the invention any of which may be combined with the display and visualization techniques disclosed in U.S. patent application Ser. No. 10/177,889.

An additional optional display technique relates to the display of a portion of the beamformed data in the display environment as further process 3-dimensional sonar data. In this embodiment, a beamformed data subset is displayed with color or translucency (alpha channel) mapped to the signal strength or range normalized signal strength within the 3D beamformed data as intersected along a 2D slice or surface. The beamformed data appears as slice through the 3D data with the beamformed data projected on that slice. This technique can also be used in the 2D profile slice display. In this case, a 2D slice of beamformed data is projected into a 2D plane with the 3D detected bottom profile and/or in-water targets corresponding to that plane plotted on top of the beamformed data.

Another optional aspect of the invention user comprehension can be improved by setting the color and/or transparency (alpha channel) of a particular target or group of targets as a function of data age. That is to say that as the time since a particular data point, surface, icon, or other representation has been detected increases, the color and/or transparency may change. For example, the detected targets may become darker, have reduced contrast, or become more transparent as they get older. This is particularly useful when a display incorporates data from more than a single transmission for use in chart/image overlay and persistence.

In yet another optional embodiment of the invention, the 3-dimensional output generated by a 3-dimensional sonar with a fixed frame of reference is displayed with radar information from an external radar sensor. In this case, the radar information should aligned to the same fixed frame of reference. In this case, the radar and sonar information should be displayed in the same display window using the same coordinate system. An additional yet optional aspect of the invention is ability for the display system to limit the display of the radar and sonar data to portions of the data which have been classified into a particular group selected for display by the user or display processor. Said target classification can be general (such as but not limited to fast moving targets, slow moving targets, etc.) or specific (such as but not limited to swimmer, dolphin, fish, boat, wake, buoy, etc.) and said classification can be performed by any combination of inter-ping tracking, geometric, spatial, active spectral, passive spectral, or other classification methods. An another optional feature of the invention allows for the overlay of said sonar and radar information on top of a geo-referenced chart, map, aerial image or other externally generated geo-referenced data set.

It will be understood that various modifications may be made to the embodiments disclosed herein. Therefore, the above description should not be construed as limiting, but merely as exemplification of the various embodiments. Those skilled in the art will envision other modifications within the scope and spirit of the claims appended hereto.

What is claimed is:

1. A 3-dimensional sonar system with a fixed frame of reference comprising:
a transmitter;
a receiver array;
a single ping processor configured to operate on an echo received from a single transmission including means to match filter sonar sensor data, optionally compensate for self Doppler, beamform sonar sensor data, extract bottom targets from beamformed data, and extract in-water targets from the beamformed data; and
a multi ping processor configured to operate on the outputs of multiple pings from the single ping processor including means to detect tracks from in-water targets.

2. A sonar system according to claim 1, further including a graphical user interface display for sonar data output;
wherein said display includes one or more forms of ancillary navigation data and said one or more forms of ancillary navigation data is oriented to the same fixed frame of reference as the sonar system; and
ancillary data is displayed with the same frame of reference as the sonar data using the same coordinate axes.

3. A sonar system according to claim 2, wherein the targets detected by the sonar are referenced to a geographical location by means of geo-referencing;
wherein said ancillary navigation data is referenced to a geographical location; and
wherein said ancillary navigation data is displayed with the same geographical reference as the sonar data using the same coordinate axes.

4. A sonar system according to claim 2, wherein said ancillary data includes radar information from a radar located aboard the same platform as the sonar and wherein the orientation between the radar sensor and the sonar sensor is constant.

5. A sonar system according to claim 3, wherein said ancillary data includes the nautical chart data, weather data, water current data, water temperature data, water salinity data, wind data, underwater bathymetric data, aerial photography data, 2-dimensional sonar imagery data, land topography data, other vessel location data, land map data or land topography data.

6. A sonar system according to claim 5, wherein said ancillary data includes radar data; and
wherein said radar data has been referenced to a geographical location, and said radar sensor is not located aboard the same platform as the sonar.

7. A 3-dimensional sonar system with a fixed frame of reference comprising:
a transmitter;
a receiver array;
a single ping processor configured to operate on a echoes received from a single transmission including means to match filter sonar sensor data, optionally compensate for self Doppler, beamform sonar sensor data, extract bottom targets from beamformed data, and extract in-water targets from the beamformed data; and
a multi ping processor configured to operate on the outputs of multiple pings from the single ping processor including means to fuse information about bottom targets and/or in-water targets from multiple transmissions.

8. A multi ping sonar processing system configured to operate on the outputs of multiple pings from a single ping processor comprising:
means to fuse information about bottom targets and/or in-water targets from multiple transmissions;
wherein said single ping processor outputs are created by multiple 3-dimensional sonars with a common fixed frame of reference.

9. A multi ping sonar processing system according to claim 8 configured to operate on the fused outputs of multiple pings from multiple single ping processors including means to detect tracks from in-water targets.

10. A 3-dimensional sonar system with a fixed frame of reference comprising:
a transmitter;
a receiver array;
a single ping processor configured to operate on a echoes received from a single transmission including means to match filter sonar sensor data, optionally compensate for self Doppler, beamform sonar sensor data, extract bottom targets from beamformed data, and extract in-water targets from the beamformed data; and
a graphical user interface display where target detections are represented by icons whose color, size, coloring intensity, transparency, flashing rate, and/or decorations are dynamically determined as a function of target detection aging.
